(19) United States
(12) Patent Application Publication
(10) Pub. No.: US 2012/0160112 A1
(43) Pub. Date: Jun. 28, 2012

(54) Local Printing Apparatus And Method

(75) Inventors: Eun Soo Hwang, Seoul (KR); Jin Sung Kim, Suwon-si (KR); Young Jeong Kim, Gwangmyeong-si (KR); Jong Woo Lee, Suwon-si (KR); Young Tae Cho, Suwon-si (KR); Dong Min Kim, Suwon-si (KR); Tae Young Ra, Yongin-si (KR); Eui Sun Choi, Seoul (KR); Eun Ah Park, Yongin-si (KR)

(73) Assignee: SAMSUNG ELECTRONICS CO., LTD., Suwon-si (KR)

(21) Appl. No.: 13/333,403

(22) Filed: Dec. 21, 2011

(30) Foreign Application Priority Data
Dec. 27, 2010 (KR) 10-2010-0135434

(51) Int. Cl. B44B 5/00; B44C 1/24; B41K 1/38

(52) U.S. Cl. 101/32; 101/3.1; 101/335; 101/416.1

(57) ABSTRACT

According to example embodiments, a printing apparatus includes a wafer delivery unit configured to move and support a wafer, an optical microscope configured to inspect the wafer, a pattern transfer unit configured to display a position of a defect on the wafer detected using the optical microscope.

### CROSS-REFERENCE TO RELATED APPLICATION

This application claims priority under 35 U.S.C. 119 to the benefit of Korean Patent Application No. 2010-0135434, filed on Dec. 27, 2010 in the Korean Intellectual Property Office, the entire disclosure of which is incorporated herein by reference.

### BACKGROUND

1. Field

Example embodiments relate to a printing apparatus to transfer a fine pattern to a local region.

2. Description of the Related Art

A semiconductor patterning process may be an ultra-precision process that may form a pattern of several tens of nanometers. Wafers may be contaminated by small particles during semiconductor manufacturing and/or patterning processes. The contamination by small particles may deteriorate performance, reduce yields, and/or result in defective products.

Efforts to reduce particle contamination during semiconductor manufacturing are being conducted by semiconductor manufacturers. Particle analysis methods to recognize the kinds and/or components of contamination sources, such as Scanning Electron Microscopy (SEM) and/or Transmission Electron Microscopy (TEM), may be used.

### SUMMARY

Example embodiments relate to a printing apparatus to transfer a pattern to a position of a defect on a wafer so as to enable search and analysis of the defect.

Example embodiments also relate to a printing apparatus to transfer a pattern regardless of a surface irregularity of a wafer containing a defect.

In accordance with example embodiments, a printing apparatus includes a wafer delivery unit configured to move and support a wafer, an optical microscope configured to inspect the wafer, and a pattern transfer unit configured to display a position of a defect on the wafer detected using the optical microscope.

The pattern transfer unit may include a dispenser to discharge a functional material, a blade to spread the functional material discharged from the dispenser, and an elastic polymer stamp to transfer the functional material to the wafer.

The elastic polymer stamp may include embossed portions to come into contact with the functional material and debossed portions between the embossed portions.

The printing apparatus may further include a drive unit configured to vertically move the pattern transfer unit.

The functional material may include at least one of a liquid-phase material, a metallic ink, an insulating film material, and polymers.

The blade may include any one of a thin plastic, a metal blade, and a cylindrical bar.

The pattern transfer unit may further include a force sensor configured to sense a contact force between the elastic polymer stamp and the wafer.

The dispenser may be configured to discharge the functional material by at least one of forming droplets of a small quantity of liquid, spraying a small quantity of liquid, and coating a thin liquid film by pushing liquid through a thin linear slit via movement thereof.

The wafer delivery unit may include a frame, a flat-plate table movably connected to the frame, and a stage movably connected to the flat-plate table to support the wafer.

In accordance with example embodiments a printing apparatus, used to display a position of a defect on a wafer, may include a pattern transfer unit configured to transfer a functional material to the wafer.

The pattern transfer unit may include a dispenser to discharge the functional material, a blade to align the functional material discharged from the dispenser, an embossed elastic polymer stamp to come into contact with the functional material aligned using the blade, and a drive unit configured to vertically move the pattern transfer unit.

The elastic polymer stamp may include embossed portions to come into contact with the functional material and debossed portions between the embossed portions.

The functional material may include at least one of a liquid-phase material, a metallic ink, an insulating film material, and polymers.

The dispenser may be configured to discharge the functional material by at least one of forming droplets of a small quantity of liquid, spraying a small quantity of liquid, and coating a thin liquid film by pushing liquid through a thin linear slit via movement thereof.

The printing apparatus may further include a wafer delivery unit configured to deliver the wafer. The wafer delivery unit may include a frame, a flat-plate table movably connected to the frame, and a stage movably connected to the flat-plate table.

The pattern transfer unit may further include a force sensor configured to measure contact force between the embossed elastic polymer stamp and the stage.

In accordance with example embodiments, a printing method to form a pattern on a defect present on a wafer detected using an optical microscope, includes applying a functional material to a flat plate, causing the functional material to adhere to an embossed elastic polymer stamp, drying the functional material adhered to the embossed elastic polymer stamp, and displaying a pattern on the defect of the wafer by causing the embossed elastic polymer stamp having functional material adhered thereon to come into contact with the wafer in a position of the wafer where the defect is located.

The elastic polymer stamp may include embossed portions to come into contact with the functional material and debossed portions between the embossed portions.

The printing method may further include aligning the functional material applied to the flat plate using a blade.

The printing method may further include measuring contact force between the embossed elastic polymer stamp and the wafer using a force sensor.

### BRIEF DESCRIPTION OF THE DRAWINGS

These and/or other aspects of example embodiments will become apparent and more readily appreciated from the following description of non-limiting embodiments, as illustrated in the accompanying drawings in which like reference characters refer to the same parts throughout the different views. The drawings are not necessarily to scale, emphasis instead being placed upon illustrating the principles of inventive concepts. In the drawings:

FIG. 1 is a view schematically illustrating a printing apparatus according to example embodiments;

FIG. 2 is a perspective view schematically illustrating a pattern transfer unit of a printing apparatus according to example embodiments;

FIG. 3 is a perspective view schematically illustrating an elastic polymer stamp used in a pattern transfer unit of the printing apparatus according to example embodiments;

FIG. 4 is a diagrammatic view illustrating a process of adhering functional material to an embossed portion of the elastic polymer stamp according to example embodiments; and

FIGS. 5 to 10 are diagrammatic views of a pattern transfer process using a pattern transfer unit according to example embodiments.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey concepts of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

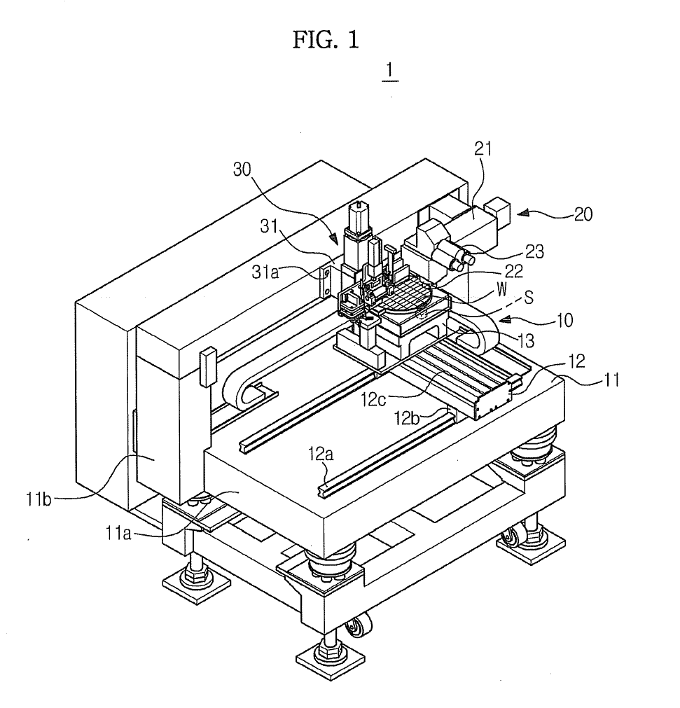

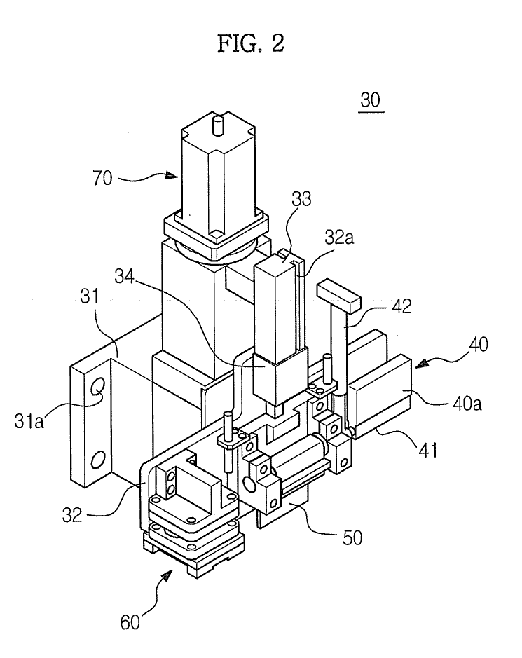

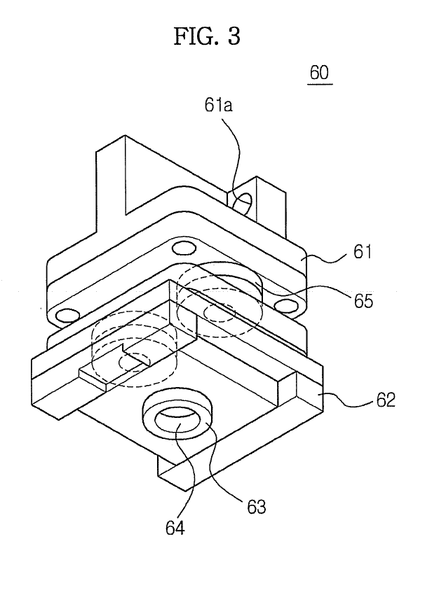

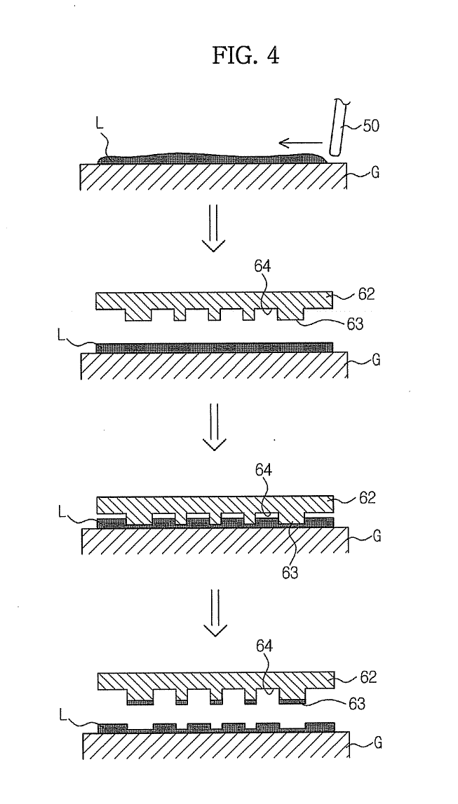

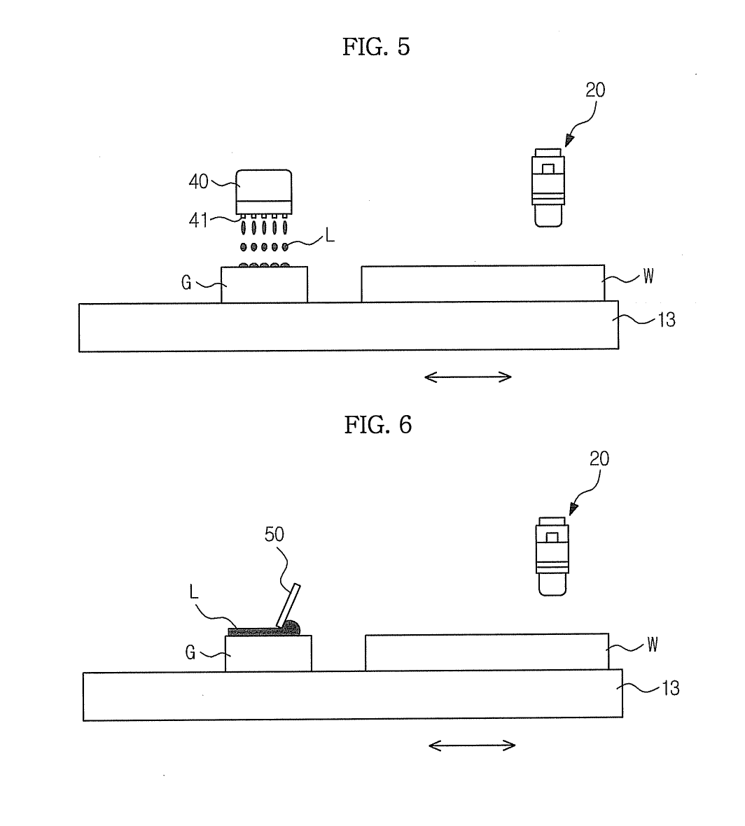

FIG. 1 is a view schematically illustrating a printing apparatus according to example embodiments, FIG. 2 is a perspective view schematically illustrating a pattern transfer unit of a printing apparatus according to example embodiments, FIG. 3 is a perspective view schematically illustrating an elastic polymer stamp used in a pattern transfer unit of the printing apparatus according to example embodiments, FIG. 4 is a diagrammatic view illustrating a process of adhering functional material to an embossed portion of the elastic polymer stamp according to example embodiments, and FIGS. 5 to 10 are diagrammatic views of a pattern transfer process using a pattern transfer unit according to example embodiments.

As illustrated in FIG. 1, a printing apparatus 1 includes a wafer delivery unit 10 to deliver a wafer W, an optical microscope 20 to detect the wafer W, and a pattern transfer unit 30 to display a position of a defect on the wafer W detected by the optical microscope 20.

The wafer delivery unit 10 includes a frame 11, a flat-plate table 12 movably installed on the frame 11, and a stage 13 mounted on the flat-plate table 12 to support the wafer W.

The frame 11 includes a horizontal support 11a, on which first rails 12a are installed in a longitudinal direction of the frame 11, and a vertical support 11b vertically extending upward from one end of the horizontal support 11a.

The first rails 12a on the horizontal support 11a include a pair of parallel rails. The flat-plate table 12 is provided at a lower surface thereof with moving members 12b to allow the flat-plate table 12 to move on the first rails 12a of the horizontal support 11a.

The flat-plate table 12 is provided in a transverse direction of the frame 11 with second rails 12c to enable movement of the stage 13.

With this configuration, the wafer W is movable in longitudinal and transversal directions (i.e. in length and width directions) of the frame 11 along the first and second rails 12a and 12c by the stage 13 and the flat-plate table 12.

The optical microscope 20 to inspect the wafer W is installed to one side of an upper end of the vertical support 11b.

The optical microscope 20 may be used to search patterns and defects throughout the wafer W. The optical microscope 20 includes a main body 21, an eyepiece 23 provided at one side of an upper surface of the main body 21, through which an observer views the wafer W, and an objective 22 provided at the center of a lower surface of the main body 21, through which the observer views the wafer W at a position spaced apart from the wafer W by a desired (and/or alternatively predetermined) distance.

The pattern transfer unit 30 is installed adjacent to one side of the optical microscope 20 and serves to display a position of a defect on the wafer W searched via the optical microscope 20. The pattern transfer unit 30 may transfer a pattern to the position of the defect.

As illustrated in FIGS. 2 and 3, the pattern transfer unit 30 is fixed to the upper end of the vertical support 11b by a fixture 31 at a position spaced apart from the optical microscope 20 by a desired (and/or alternatively predetermined) distance.

The pattern transfer unit 30 includes a dispenser 40, a blade 50, an elastic polymer stamp 60, and a drive unit 70.

The fixture 31 of the pattern transfer unit 30 may include bolt holes 31a at both ends. Bolts (not shown) may be used to fasten the fixture 31 to the vertical support 11b of the frame 11. The drive unit 70 may be configured to vertically move the pattern transfer unit 30 and the drive unit 70 may be secured to a front surface of the fixture 31.

The dispenser 40, the blade 50, and the elastic polymer stamp 60 are arranged in a line and are secured to a supporting member 32 provided at a front surface of the drive unit 70.

The supporting member 32 includes a guide 33 having a vertical guide slot 32a. The supporting member 32 may be vertically moved by the drive unit 70, and the supporting member may include a mover 34 to move along the guide slot 32a.

The dispenser 40 is located at one end of the supporting member 32 and serves to apply a functional material L (see FIG. 4) to a flat plate G (see FIG. 4). The functional material L may be fed from an external source. The dispenser 40 may be configured to eject a liquid-phase functional material L onto the flat plate G placed at one side of the wafer W.

The dispenser 40 includes a functional material inlet 42 formed at a body 40a thereof to receive the functional material L from an external source, and a functional material outlet 41 formed at the bottom of the main body 40a to discharge the functional material L fed into the body 40a toward the flat plate G.

The flat plate G may be made of glass or metal and the flat plate G may be located on the stage 13 like the wafer W.

The functional material L may includes at least one of a liquid-phase material, a metallic ink, an insulating film material, and polymers.

After the functional material L is discharged onto the flat plate G by the dispenser 40, the functional material L may be spread by the blade 50 in order to thinly coat the functional material L on an upper surface of the flat plate G.

The outlet 41 of the dispenser 40 may discharge the functional material L using any one of a method of forming droplets of a small quantity of the functional material L, a method of spraying the functional material L, and a method of coating a thin film of the functional material L by pushing the functional material L through a thin linear slit via movement thereof.

To spray the functional material L, the outlet 41 may take the form of a sprayer.

The blade 50 includes any one of a thin plastic or metal blade and a cylindrical bar. The blade 50 serves to provide the functional material L with a thickness to achieve a desired pattern thickness on the wafer W.

The functional material L thinly coated on the flat plate G by the blade 50 is brought into contact with the elastic polymer stamp 60.

The elastic polymer stamp 60 includes a stamp supporting piece 61, an embossed stamp 62, and an angle adjustor 65 provided between the stamp supporting piece 61 and the embossed stamp 62.

The stamp supporting piece 61 is provided at both ends thereof with bolt holes 61a so bolts (not shown) may be used to fasten the stamp supporting piece 61 to the supporting member 32.

The embossed stamp 62 is provided at a lower end of the stamp supporting piece 61. The embossed stamp 62 includes embossed portions 63 defining an outwardly protruding pattern, and debossed portions 64 between the embossed portions 63. While FIG. 3 illustrates the embossed stamp 62 includes one debossed portion 64 and one embossed portion 63, example embodiments are not limited thereto. Example embodiments may include an embossed stamp 62′, as illustrated in FIG. 4, containing more of fewer embossed portions 63 and debossed portions 64.

The angle adjustor 65 provided between the stamp supporting piece 61 and the embossed stamp 62 may take the form of a screw having fine threads (not shown) and serve to control the angle of the embossed stamp 62 based on the horizontality of the wafer W.

With the above-described configuration, during implementation of a process of transferring a micro pattern to a position of a defect on the wafer W which will be described hereinafter, the angle of the embossed stamp 62 coming into contact with the wafer W may be adjusted so the embossed stamp 62 and the wafer W are parallel to each other.

A force sensor S to measure contact force between the embossed stamp 62 and the wafer W is installed at a lower portion of the stage 13. Providing the force sensor S allows the wafer W and the embossed stamp 62 to come into contact with each other at a desired and/or preset force such that only the functional material L adhered to the embossed portions 63 of the embossed stamp 62 is transferred to the wafer W, which may reduce and/or minimize deformation of the embossed stamp 62 and realize delicate transfer of a micro pattern.

In addition, even if the wafer W has an irregular surface provided with bosses or indentations, a portion of the wafer W where a micro-pattern of the functional material L is not transferred by the embossed portions 63 is free from physical or chemical effects since the embossed stamp 62 of the elastic polymer stamp 60 may be controlled so only the embossed portions 63 of the embossed stamp 62 come into contact with the wafer W.

The process of adhering functional material L to embossed portions 63 of the embossing stamp 60, as illustrated in FIG. 4, includes thinly coating the functional material Lon the flat plate G. The functional material L may be sprayed from the dispenser 40 onto the flat plate G. The flat plate G may be provided near the wafer W. The blade 50 may be used to spread the functional material L on the flat plat G to make the thickness of the functional material L more uniform. Next, the embossed stamp 62′ of the elastic polymer stamp 60 may be moved to contact the functional material L coated on the flat plate G in order for a part of the functional material L to adhere to the embossed stamp 62′.

In this case, the height of the embossed portions 63 and the contact time and force between the embossed portions 63 and the functional material L may be controlled so the functional material L only adheres to the embossed portions 63 of the embossed stamp 62.

After the functional material L is subjected to natural or forced drying for a desired (and/or alternatively predetermined) time, the functional material L adhered to the embossed portions 63 of the embossed stamp 62 is brought into contact with the position of the defect on the wafer W so as to transfer a micro-pattern to the position of the defect.

While FIG. 4 illustrates a process using embossed stamp 62′, example embodiments are not limited thereto, and a printing apparatus according to example embodiments may be used for processes that transfer micro-patterns to the wafer using an embossed stamp containing more and/or fewer embossed portions 63 and debossed portions 64, such as the embossed stamp 62 illustrated in FIG. 3.

A method of transferring the micro-pattern to the position of the defect on the wafer W using the pattern transfer unit 30 according to example embodiments will be described hereinafter with reference to FIGS. 5 to 10.

As shown in FIG. 5, the wafer may be placed on the stage 13. The stage 13 is movable by the flat-plate table 12. The wafer W may be moved to a position beneath the objective 22 of the optical microscope 20 so an observer can search for a defect on the wafer W through the eyepiece 23 of the optical microscope 20.

Once a position of the defect on the wafer W to be analyzed is searched, a process of transferring a pattern to the position of the defect using the pattern transfer unit 30 may be performed.

To this end, the flat plate G placed on the stage 13 may be moved to a position beneath the dispenser 40 via movement of the stage 13, and the functional material L is discharged from the outlet 41 of the dispenser 40 onto the flat plate G (see FIG. 5).

Once the functional material L is discharged onto the flat plate G, the functional material L on the wafer W may be spread by the blade 50 to have an appropriate thickness.

In this case, since the blade 50 is kept stationary, the stage 13 and the flat plate G are moved to form a layer of the functional material L having the appropriate thickness (see FIG. 6).

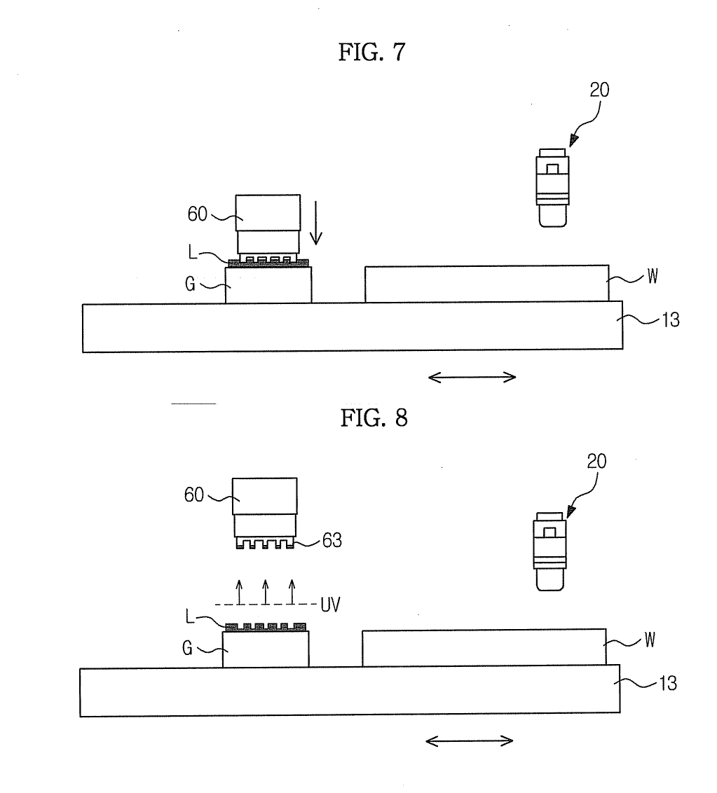

As shown in FIG. 7, the functional material L coated on the flat plate G is brought into contact with the embossed stamp 62 of the elastic polymer stamp 60.

In this case, to allow the thinly coated functional material L to be adhered only to the embossed portions 63 of the embossed stamp 62′, a contact force of the embossed stamp 62′ is controlled using a force sensor S (see FIG. 1).

In this case, the process of transferring the functional material L to the embossed stamp 62′ may be controlled by differentiating the process time, movement speed and/or distance of the embossed stamp 62′ toward or away from the functional material L, and surface properties of the embossed stamp 62′ and the wafer W.

After a desired (and/or alternatively predetermined) time passes in a state in which the functional material L comes into contact with the embossed stamp 62′ of the elastic polymer stamp 60, the embossed stamp 62′ is moved away from the functional material L (see FIG. 8). Then, after the functional material L transferred only to the embossed portions 63 of the embossed stamp 62′, the functional material L on the embossed portions 63 is naturally or forcibly dried for a desired (and/or alternatively predetermined time). The stage 13 is moved such that the defect on the wafer W, to which a pattern will be transferred, is located beneath the embossed stamp 62′ of the elastic polymer stamp 60.

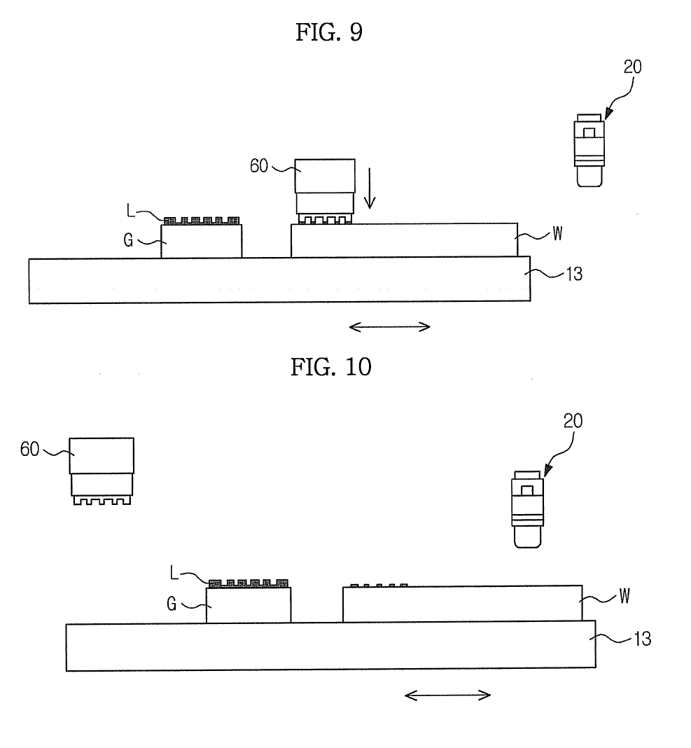

Then, as shown in FIG. 9, the elastic polymer stamp 60 may be moved downward by the drive unit 70 so the functional material L adhered to the embossed portions 63 of the embossed stamp 62′ can be transferred to the position of the defect on the wafer W.

After the pattern is transferred to the defect on the wafer W, the stage 13 may be returned to an original position thereof (see FIG. 10).

With the pattern transfer method using the pattern transfer unit 30 according to example embodiments, even a defect of 100 nm to 1 μm on the wafer searched by the optical microscope 20 may be visibly displayed, enabling easy removal and analysis of a contaminant source.

As is apparent from the above description, according to example embodiments, a pattern may be formed on and/or around a defect on a wafer to display a position of the defect.

Further, positioning the pattern at a desired position on the wafer containing a circuit pattern has the effect of transferring the pattern without having physical or chemical effects on the existing pattern.

Furthermore, using an elastic polymer stamp provided with embossed portions has the effect of transferring the pattern regardless of a surface irregularity of a circuit pattern on the wafer.

Although a few example embodiments have been shown and described, it would be appreciated by those skilled in the art that changes may be made in form and detail without departing from the principles and spirit the claims.

What is claimed is:

1. A printing apparatus comprising:
a wafer delivery unit configured to move and support a wafer;
an optical microscope configured to inspect the wafer; and
a pattern transfer unit configured to display a position of a defect on the wafer detected using the optical microscope.

2. The apparatus according to claim 1, wherein the pattern transfer unit includes:
a dispenser to discharge functional material,
a blade to spread the functional material discharged from the dispenser, and
an elastic polymer stamp to transfer the functional material to the wafer.

3. The apparatus according to claim 2, wherein the elastic polymer stamp includes:
embossed portions to come into contact with the functional material; and
debossed portions between the embossed portions.

4. The apparatus according to claim 2, further comprising:
a drive unit configured to vertically move the pattern transfer unit.

5. The apparatus according to claim 2, wherein
the functional material includes at least one of a liquid-phase material, a metallic ink, an insulating film material, and polymers.

6. The apparatus according to claim 2, wherein
the blade includes one of a thin plastic blade, a metal blade, and a cylindrical bar.

7. The apparatus according to claim 6, wherein the pattern transfer unit further includes:
a force sensor configured to sense a contact force between the elastic polymer stamp and the wafer.

8. The apparatus according to claim 2, wherein the dispenser is configured to discharge the functional material by at least one of:
forming droplets of a small quantity of liquid,
spraying a small quantity of liquid, and
coating a thin liquid film by pushing liquid through a thin linear slit via movement thereof.

9. The apparatus according to claim 1, wherein the wafer delivery unit includes:
a frame,
a flat-plate table movably connected to the frame, and
a stage movably connected to the flat-plate table to support the wafer.

10. A printing apparatus, used to display a position of a defect on a wafer, comprising:
a pattern transfer unit configured to transfer a functional material to the wafer.

11. The apparatus according to claim 10, wherein the pattern transfer unit includes:
a dispenser to discharge the functional material,
a blade to align the functional material discharged from the dispenser,
an embossed elastic polymer stamp to come into contact with the functional material coated using the blade, and
a drive unit configured to vertically move the pattern transfer unit.

12. The apparatus according to claim 11, wherein
the elastic polymer stamp includes embossed portions to come into contact with the functional material and debossed portions between the embossed portions.

13. The apparatus according to claim 11, wherein the dispenser is configured to discharge the functional material by at least one of:
forming droplets of a small quantity of liquid,
spraying a small quantity of liquid, and
coating a thin liquid film by pushing liquid through a thin linear slit via movement thereof.

14. The apparatus according to claim 11, further comprising:
a wafer delivery unit configured to deliver the wafer, the wafer delivery unit includes,
a frame,
a flat-plate table movably connected to the frame, and
a stage movably connected to the flat-plate table.

15. The apparatus according to claim 14, wherein the pattern transfer unit further includes:
a force sensor configured to measure contact force between the embossed elastic polymer stamp and the stage.

16. The apparatus according to claim 10, wherein
the functional material includes at least one of a liquid-phase material, a metallic ink, an insulating film material, and polymers.

17. A printing method to form a pattern on a defect present on a wafer detected using an optical microscope, comprising:
applying a functional material to a flat plate;
causing the functional material to adhere to an embossed elastic polymer stamp;
drying the functional material adhered to the embossed elastic polymer stamp; and
displaying a pattern on the defect of the wafer by causing the embossed elastic polymer stamp having functional material adhered thereon to come into contact with the wafer in a position of the wafer where the defect is located.

18. The method according to claim 17, wherein the elastic polymer stamp includes:
embossed portions to come into contact with the functional material,
and debossed portions between the embossed portions.

19. The method according to claim 17, further comprising:
aligning the functional material applied to the flat plate using a blade.

20. The method according to claim 17, further comprising:
measuring contact force between the embossed elastic polymer stamp and the wafer using a force sensor.
